(19) United States
(12) Patent Application Publication
(10) Pub. No.: US 2007/0169092 A1
(43) Pub. Date: Jul. 19, 2007

(54) Image forming apparatus capable of updating firmware of optional device and method thereof

(75) Inventor: Sang-jin Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/485,353

(22) Filed: Jul. 13, 2006

(30) Foreign Application Priority Data
Nov. 11, 2005 (KR) 2005-108120

(51) Int. Cl. G06F 9/44

(52) U.S. Cl. 717/168

(57) ABSTRACT

An image forming apparatus capable of updating a firmware of an optional device and method thereof are provided. The image forming apparatus includes a plurality of optional devices each having firmware, and a control part to compare the firmware of each device and update each firmware of the plurality of optional devices to a newest firmware of the compared firmware. If the firmware is to be updated when the optional device is added to the image forming apparatus and the firmware of the existing optional device and the firmware of the added optional device are not the same, the firmware can be updated without requiring a download of firmware from the outside which provides more convenience for a user.

### CROSS-REFERENCE TO RELATED APPLICATIONS

This application claims the benefit under 35 U.S.C. § 119(a) of Korean Patent Application No. 2005-108120 filed on Nov. 11, 2005, the entire disclosure of which is hereby incorporated by reference.

### BACKGROUND OF THE INVENTION

1. Field of the Invention

The present invention relates to an image forming apparatus capable of updating the firmware of an optional device and method thereof. More particularly, the present invention relates to an image forming apparatus that can update firmware without requiring a download from an outside when an optional device is added to an image forming apparatus, if it is detected that the firmware of an existing optional device and the firmware of the added optional device are not identical and accordingly the firmware needs to be updated, and method thereof.

2. Description of the Related Art

FIG. 1 is a view for explaining a method of updating the firmware of a cassette in a conventional image forming apparatus. Referring to FIG. 1, the method will be explained.

An image forming apparatus outputs print data onto a printing paper by using a developer such as a toner. The image forming apparatus includes a printer, a copier, a facsimile and a multifunction peripheral device.

A plurality of paper feeding cassettes can be mounted to an image forming apparatus as shown in FIG. 1. A control board 20 may be mounted to the paper feeding cassette to control the cassette itself. The control board 20 comprises firmware (F/W) 30 which is a program to control a motor or a sensor of the cassette in order to supply the printing papers and input the control information to a main board (not shown) of a main body 10, and a central processing unit (CPU, not shown) to process the firmware.

Additional cassettes may also be mounted, if necessary, after the image forming apparatus is purchased. At this time, if the control board is mounted to each cassette, problems may occur. In other words, problems may occur when the firmware of the existing cassette and the firmware of the newly-added cassette are not identical, and when the firmware of the existing cassette can not support the more developed function of the firmware of the newly-added cassette. Accordingly, after adding a new cassette, the firmware of each cassette should be updated.

Conventionally, firmware is downloaded from a server over a network by using a personal computer (PC) to update the firmware of the cassette of the image forming apparatus. However, use of the PC is inconvenient since a user must download the firmware to update the apparatus.

Accordingly, there is a need for an improved image forming apparatus and method for updating firmware when using an optional device.

### SUMMARY OF THE INVENTION

Accordingly, exemplary embodiments of the present invention are to address at least the above problem and/or disadvantages and to provide at least the advantages described below. Therefore, an object of the present invention is to provide an image forming apparatus which can update, without requiring a download of firmware from an outside when an optional device is added to the image forming apparatus, a firmware of an existing optional device when a firmware of the added optional device and the firmware of the existing optional device are not identical and accordingly the firmware need be updated so as to provide enhanced user convenience, and method thereof.

To achieve the above-described object, there is provided a method of updating the firmware of an optional device mounted to an image forming apparatus including operations of comparing each firmware of a plurality of optional devices mounted to the image forming apparatus, and updating each firmware of the plurality of optional devices to a newest firmware of the compared firmware.

The method may further include an operation of receiving information from a user on whether the firmware of the plurality of optional devices are updated.

The optional devices may be paper feeding cassettes.

The operation of updating may be performed when at least one optional device is additionally mounted to the image forming apparatus or when a command is received from a user to update the firmware of the plurality of optional devices.

The operation of receiving may receive from one of an operation panel (OPE) of the image forming apparatus and a host to control the image forming apparatus.

To achieve the above-described object, there is provided an image forming apparatus capable of updating a firmware of an optional device including a plurality of optional devices with each firmware, and a control part to compare each firmware and update each firmware of the plurality of optional devices to a newest firmware of the compared firmware.

The apparatus may further include a user interface part receiving information from a user on whether the firmware of the plurality of optional devices are updated. The control part may update the firmware if a command is received via the user interface part to update the firmware of the plurality of optional devices.

The optional devices may be paper feeding cassettes.

The apparatus may further include a storage part to receive the newest firmware from the optional device with the newest firmware and store the newest firmware.

The control part may update the firmware of the optional devices except for the optional device with the newest firmware to the newest firmware stored in the storage part.

The control part may perform updating when at least one optional device is additionally mounted to the image forming apparatus.

The user interface part may be one of an operation panel (OPE) of the image forming apparatus and a user interface (UI) of a host to control the image forming apparatus.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a view for explaining a method for updating a firmware of an optional cassette of a conventional image forming apparatus;

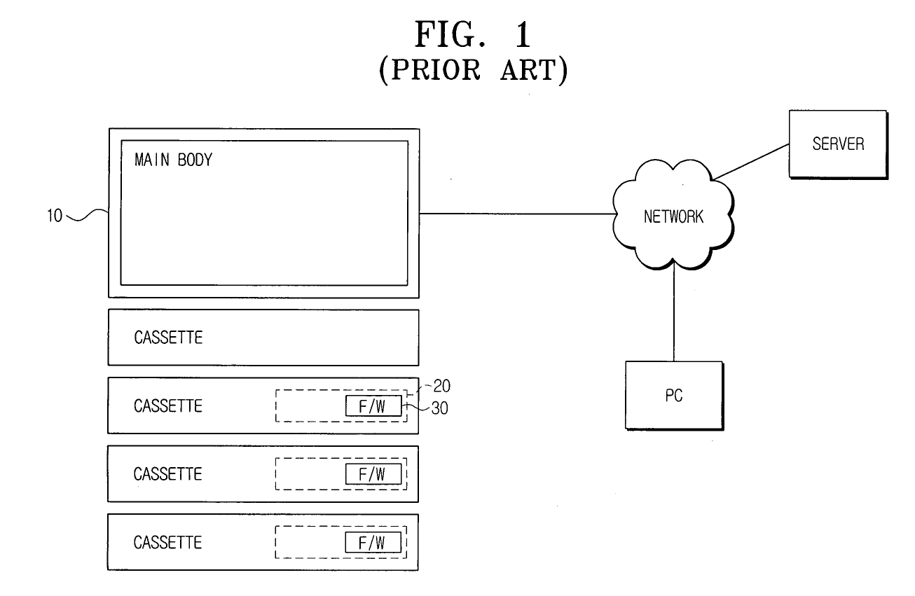

FIG. 2 is a block diagram of an image forming apparatus capable of updating the firmware of an optional device according to an exemplary embodiment of the present invention; and

FIG. 3 is a flowchart for explaining a method for updating the firmware of an optional device mounted to an image forming apparatus according to an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity. Those of ordinary skill in the art will recognize that various changes and modifications of the exemplary embodiments described herein can be made without departing form the scope and spirit of the invention.

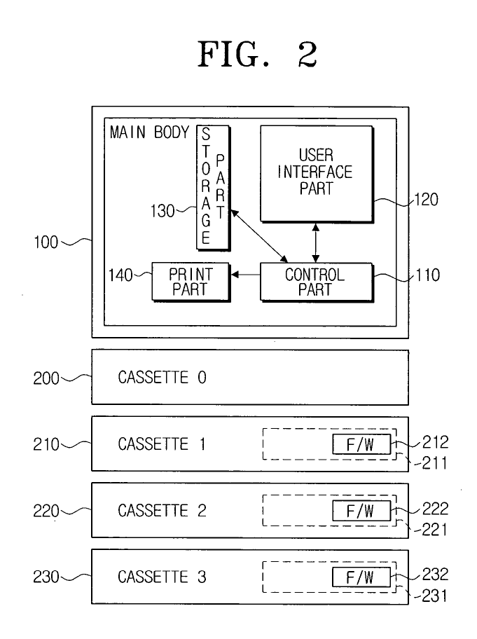

FIG. 2 is a block diagram of an image forming apparatus capable of updating the firmware of an optional device according to an exemplary embodiment of the present invention. In the exemplary embodiment, the optional device refers to a device that can be optionally added in a quantity of one or more to the image forming apparatus. In this exemplary embodiment, a paper feeding cassette is exemplified as the optional device.

The image forming apparatus includes a paper feeding cassette and a main body 100 to form and output an image on a printing paper supplied from the paper feeding cassette.

The paper feeding cassette is one of the optional devices of the image forming apparatus and includes a cassette 200 without a control board and cassettes 210, 220, 230 each with a control board. Each of the control board 211, 221, 231 includes firmware (F/W) 212, 222, 232 and a central processing unit (CPU, not shown) to process the firmware.

The firmware is stored into a programmable read only memory (PROM) to enhance performance of an image forming apparatus such as a printer. Alternatively, the firmware may be stored into a flash memory which is a non-volatile memory that can delete or reprogram data, or other types of memory. The firmware 212, 222, 232 provided in the control board of each paper feeding cassette refer to programs which control a motor or a sensor of the paper feeding cassette to supply a printing paper and input the control information to a control part 110 of the main body 100.

The main body 100 includes a control part 110 and a print part 140. In the exemplary embodiment, the main body may also include a storage part 130 and/or a user interface part 120.

The print part 140 prints print data under the control of the control part 110 as in the conventional apparatus.

The control part 110 can sense that at least one additional cassette is additionally mounted to the image forming apparatus. Generally, when power to the image forming apparatus is turned on, the control part 110 checks all the connected hardware. At this time, the control part 110 can sense that at least one additional cassette is additionally mounted to the image forming apparatus. For example, the control part 110 can set a flag to be on which indicates whether the additional cassette is additionally mounted. Or, when at least one additional cassette is additionally mounted to the image forming apparatus, the control part 110 may directly sense that the new hardware is mounted to the image forming apparatus.

If at least one additional cassette is additionally mounted to the image forming apparatus, the control part 110 compares the firmware of each of the plurality of cassettes to search for the newest firmware and updates each firmware of the plurality of cassettes to reflect the newest firmware found during the search.

In FIG. 2, the cassette0 200 is provided in the image forming apparatus and the cassette1 210, cassette2 220, cassette3 230 are additionally mounted to the image forming apparatus simultaneously or intermittently. Hereinafter, an exemplary embodiment will be explained wherein the cassette3 230 is newly added to the image forming apparatus with the cassette0 200, cassette1 210, and cassette2 220 already present.

The control part 110 may sense the addition of cassette3 either simultaneously when the cassette3 230 is added to the image forming apparatus, or when the power to the image forming apparatus is turned on after the cassette3 230 is added to the image forming apparatus.

If the addition of the cassette3 230 is sensed, the control part 110 compares firmware 212, 222, 232 of the cassette1 210, cassette2 220 and cassette3 230 respectively, which have the control boards among the cassettes mounted to the image forming apparatus, to search for the newest firmware.

Like the cassettes 200, most of the cassettes provided to the image forming apparatus do not have a control board. In such a case, the firmware of the control part 110 can control the cassette0 200. Generally, the firmware of the control part 110 is necessary for an image forming apparatus to form and print an image onto a printing paper, and the firmware may function to control the cassette that is one of the optional devices. Accordingly, unless it has separate firmware to control a motor or a sensor of the cassette, the control part 110 compares only the firmware 212, 222, 232 of the cassettes themselves. Alternatively, if it has separate firmware to control the motor or the sensor of the cassette, the control part 110 may compare its own firmware with the firmware 212, 222, 232 of the cassettes themselves.

The control part 110 may read version information of the firmware 212, 222, 232 to compare them. At this time, the control part 110 may read models of image forming apparatuses, types of cassette, versions of firmware and the like, which can be supported by the firmware 212, 222, 232 of individual cassettes 210, 220, 230, to compare them. The firmware with the highest version may be considered as the newest firmware, among the firmware supporting the image forming apparatus.

If the firmware considered newest is the firmware 222 of the cassette2 220, the control part 110 updates the firmware 212 and 232 of the other cassettes 210, 230 to the newest firmware 222. At this time, the control part 110 may control the cassette2 to transmit the firmware 222 to the cassette1 210 and the cassette3 230. In an exemplary embodiment, the main body 100 of the image forming apparatus may include a storage part 130. In an exemplary embodiment, the control part 110 may store the searched newest firmware 222 in the storage part 130 and transmit the stored firmware 222 to the cassette1 210 and the cassette3 230 to update them.

In an alternative exemplary embodiment, the firmware of the cassette can be updated by receiving, via a user interface part from a user, the information on whether the firmware of the cassette is updated. The user interface part may be an operation panel (OPE) 120 provided in the image forming apparatus, a user interface (UI, not shown) provided in a host (not shown) to control the image forming apparatus and the like.

After adding the cassette3 230 to the image forming apparatus, a user may input a command to the user interface part 120 to update the firmware of the cassette. If a user inputs the command to the user interface part 120 to update the firmware of the cassette, the control part 110 compares each firmware of the plurality of cassettes to search for the newest firmware and updates each firmware of the plurality of cassettes with the firmware considered newest.

In an exemplary embodiment, the control part 110 may sense the addition of the cassette3 230 and compare the firmware of each of the plurality of cassettes to search for the newest firmware. Then, the user interface part 120 may receive information as to whether the firmware is updated to the newest firmware. If a user inputs the command to the user interface part 120 to update the firmware of the cassette, the control part 110 updates each firmware of the plurality of cassettes to the newest firmware.

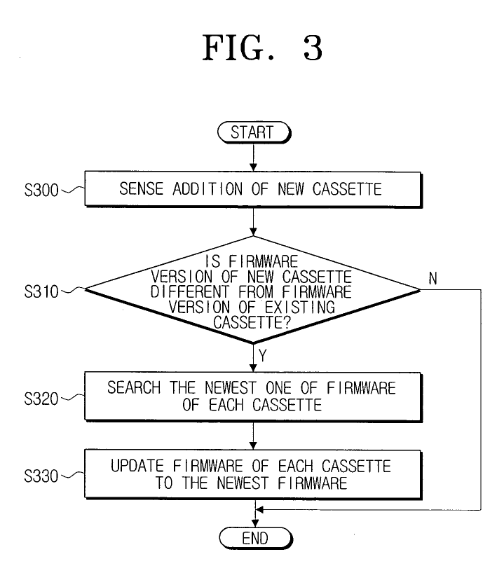

FIG. 3 is a flowchart for explaining a method of updating the firmware of an optional device mounted to an image forming apparatus according to an exemplary embodiment of the present invention.

The control part 110 senses that a new cassette is additionally mounted to an image forming apparatus (S300). The control part 110 then determines if a version of the firmware of the new cassette is different from a version of the firmware of an existing cassette (S310). If the versions are the same (S310:N), the firmware of the cassette is not updated.

If the versions are different (S310:Y), the control part 110 searches for the newest firmware among each cassette (S320). In other words, the firmware with the highest version can be searched and determined as the newest firmware among the firmware supporting the image forming apparatus to which a cassette is additionally mounted.

The control part 110 updates the firmware of the other cassettes, except for the cassette with the newest firmware, to the newest firmware searched in the operation of S320 (S330). In an exemplary embodiment, the searched newest firmware may be stored into the main body 100 and then the stored firmware may be transmitted to the other cassettes to update the firmware.

In an exemplary embodiment, the method of updating firmware explained with reference to FIG. 3 may be implemented as being included in a single function of the firmware that the control part 110 conventionally has. Additionally, the method of updating the firmware is not limited to the cassette of the image forming apparatus, but may be applied to any optional device capable of having firmware.

As described above, according to an exemplary embodiment of the present invention, if the firmware is tried to be updated when the optional device is added to the image forming apparatus and the firmware of the existing optional device and the firmware of the added optional device are not the same, the firmware can be updated without requiring a download of firmware from the outside so that a convenience of user can be provided.

While the invention has been shown and described with reference to certain exemplary embodiments thereof, it will be understood by those skilled in the art that various changes in form and details may be made therein without departing from the spirit and scope of the invention as defined by the appended claims including the full scope of equivalents thereof.

What is claimed is:

1. A method of updating firmware of an optional device mounted to an image forming apparatus, the method comprising:
comparing firmware of a plurality of optional devices mounted to the image forming apparatus; and
updating firmware of the plurality of optional devices to a newest firmware of the compared firmware.

2. The method as claimed in claim 1, further comprising:
receiving information from a user on whether the firmware of the plurality of optional devices are updated.

3. The method as claimed in claim 1, wherein the optional devices comprise paper feeding cassettes.

4. The method as claimed in claim 1, wherein the operation of updating is performed when at least one optional device is additionally mounted to the image forming apparatus.

5. The method as claimed in claim 2, wherein the operation of receiving comprises receiving from one of an operation panel (OPE) of the image forming apparatus and a host to control the image forming apparatus.

6. An image forming apparatus capable of updating firmware of an optional device, comprising:
a plurality of optional devices comprising firmware; and
a control part to compare the firmware and update the firmware of the plurality of optional devices to a newest firmware of the compared firmware.

7. The apparatus as claimed in claim 6, further comprising:
a user interface part receiving information from a user on whether the firmware of the plurality of optional devices are updated,
wherein the control part updates the firmware if a command is received via the user interface part to update the firmware of the plurality of optional devices.

8. The apparatus as claimed in claim 6, wherein the optional devices comprise paper feeding cassettes.

9. The apparatus as claimed in claim 6, further comprising:
a storage part to receive and store the newest firmware,
wherein the control part updates the firmware of the optional devices except for the optional device with the newest firmware to the newest firmware stored in the storage part.

10. The apparatus as claimed in claim 6, wherein the control part performs updating when at least one optional device is additionally mounted to the image forming apparatus.

11. The apparatus as claimed in claim 7, wherein the user interface part comprises one of an operation panel (OPE) of the image forming apparatus and a user interface (UI) of a host to control the image forming apparatus.

12. The method as claimed in claim 1, wherein the operation of updating is performed when a command is received from a user to update the firmware of the plurality of optional devices.

13. The apparatus as claimed in claim 9, wherein the storage part receives the newest firmware from one of the plurality of optional devices having the newest firmware.
